(19) United States
(12) Patent Application Publication
(10) Pub. No.: US 2022/0072833 A1
(43) Pub. Date: Mar. 10, 2022

(54) PACKAGING FILM WITH THERMOPLASTIC POLYURETHANE ELASTOMER

(71) Applicant: Bemis Company, Inc., Neenah, WI (US)

(72) Inventors: Zheng Tian, Neenah, WI (US); Ross K. Gruetzmacher, Neenah, WI (US)

(21) Appl. No.: 17/420,077

(22) PCT Filed: Dec. 31, 2018
(86) PCT No.: PCT/US2018/068151

§ 371 Date: Jun. 30, 2021

(51) Int. Cl. B32B 27/08; B32B 27/28; B32B 27/30; B32B 7/12

(52) U.S. Cl. CPC B32B 27/08; B32B 27/285; B32B 27/306; B32B 7/12; B32B 2250/05; B32B 2307/536; B32B 2307/5825; B32B 2439/06; B32B 2250/24

(57) ABSTRACT

A packaging film is described. The packaging film comprises a first layer comprising thermoplastic polyurethane elastomer. The thermoplastic polyurethane elastomer comprises a thermoplastic polyether polyurethane elastomer or a thermoplastic e polyester polyurethane elastomer. The thermoplastic polyurethane elastomer has a shore A hardness in accordance with DtN ISO 7819-1 (3s) of equal to or greater than about 35. The first layer is an inner layer of the packaging film. The packaging film also comprises a second layer comprising a first tie material. The second layer is directly adjacent the first layer. The packaging film also comprises a third layer comprising ethylene vinyl alcohol copolymer. The third layer is positioned inferior to each of the first layer and the second layer. Various embodiments of the packaging film are also described.

The present application describes a packaging film comprising thermoplastic polyurethane elastomer, specifically, a packaging film comprising a first layer of thermoplastic polyurethane elastomer (TPU), a second layer comprising a first tie material, and a third layer comprising ethylene vinyl alcohol copolymer. This packaging film provides improved mechanical toughness as compared to known packaging films.

### BACKGROUND

Ethylene vinyl alcohol copolymer (EVOH) is used in packaging films to provide an oxygen barrier to the packaging contents. However, EVOH contributes mechanical weakness to the structure, as EVOH is generally rather brittle. In various packaging films, such mechanical weakness of the EVOH decreases the mechanical toughness of the overall packaging film and the overall packaging comprising the film, negatively affecting puncture resistance, tear resistance, tensile strength, flex-crack resistance, and other toughness properties. The impact of such decrease in mechanical toughness may be readily apparent in various packaging forms, including but not limited to large-volume packaging forms such as bulk container liners, quad bags, or larger pouches or bags, or when packaging contents include sharp articles or sterilized materials (such as in aseptic packaging).

Chinese Patent Application CN 103522694 A (Jiangsu Haoda Co.) discloses a film comprising a covering layer, a barrier layer, a thermoplastic polyurethane film layer, protective layers, and bonding layers. The covering layer, the thermoplastic polyurethane film layer, and the barrier layer are sequentially arranged from top to bottom, and every two layers are connected through one bonding layer. Protective layers are arranged on each of the covering layer and the barrier layer and are connected to each of the covering layer and the barrier layer through bonding layers. This application is silent regarding the inclusion of EVOH.

International Publication Number WO 2016/069335 (Dow Global Technologies LLC) discloses a film structure comprising an outer layer of thermoplastic elastomer, a barrier layer, and a tie layer comprising thermoplastic elastomer, wherein the tie layer is disposed between the outer layer and the barrier layer. This publication is silent regarding the use of thermoplastic polyurethane elastomer in an inner layer of the film.

United States Patent No. US 9/701,445 (Witthuhn, et al.) discloses a liner for bulk containers comprising at least one sidewall comprising a layer comprising a thermoplastic oxygen barrier of ethylene vinyl alcohol copolymer and a thermoplastic elastomer. This patent is silent regarding a film comprising a separate layer of ethylene vinyl alcohol copolymer and a separate layer of thermoplastic polyurethane elastomer.

### SUMMARY

What is needed is a packaging film that comprises EVOH for barrier properties and has sufficient mechanical toughness in the form of puncture resistance, tear resistance, tensile strength, flex-crack resistance, etc. These needs are met by the packaging film described in the present application. This packaging film comprises EVOH for barrier properties and has sufficient mechanical toughness.

In a first set of embodiments, this packaging film comprises a first layer comprising thermoplastic polyurethane elastomer. The thermoplastic polyurethane elastomer comprises a thermoplastic polyether polyurethane elastomer or a thermoplastic polyester polyurethane elastomer. The thermoplastic polyurethane elastomer has a shore A hardness in accordance with DIN ISO 7619-1 (3s) of equal to or greater than about 35. In some embodiments, the thermoplastic polyurethane elastomer has a shore A hardness in accordance with DIN ISO 7619-1 (3s) of equal to or greater than about 83. In some embodiments, the thermoplastic polyurethane elastomer has a shore A hardness in accordance with DIN ISO 7619˜1 (3s) of from about 83 to about 98. The first layer is an inner layer of the packaging film.

In the first set of embodiments, the packaging film also comprises a second layer comprising a first tie material. In some embodiments, the first tie material contributes a bonding force of less than about 275.6 gram-force/centimeter (700 gram-force/inch). In some embodiments, the first tie material contributes a bonding force of from about 39.4 gram-force/centimeter (100 gram-force/inch) to about 118.1 gram-force/centimeter (300 gram-force/inch). The second layer is directly adjacent the first layer.

In the first set of embodiments, the packaging film also comprises a third layer comprising ethylene vinyl alcohol copolymer. The third layer is positioned interior to each of the first layer and the second layer.

In some embodiments of the first set of embodiments, the first layer is a core layer of the packaging film and the packaging film is palindromic in structure.

In some embodiments of the first set of embodiments, the packaging film further comprises a fourth layer comprising polyamide and a fifth layer comprising polyamide. In these embodiments, the second layer is positioned between the first layer and the fourth layer, the fourth layer is positioned between the second layer and the third layer, and the third layer is positioned between the fourth layer and the fifth layer.

In a second set of embodiments, this packaging film comprises a first layer comprising thermoplastic polyether polyurethane elastomer. The thermoplastic polyether polyurethane elastomer has a shore A hardness in accordance with DIN ISO 7619-1 (3s) of equal to or greater than about 70. In some embodiments, the thermoplastic polyether polyurethane elastomer has a shore A hardness in accordance with DIN ISO 7619-1 (3s) of equal to or greater than about 83. In some embodiments, the thermoplastic polyether polyurethane elastomer has a shore A hardness in accordance with DIN ISO 7619-1 (3s) of from about 83 to about 98. The first layer is an inner layer of the packaging film.

In the second set of embodiments, the packaging film also comprises a second layer comprising a first tie material; the second layer is directly adjacent the first layer. The packaging film also comprises a third layer comprising ethylene vinyl alcohol copolymer; the third layer is positioned interior to each of the first layer and the second layer. The packaging film also comprises a sealant layer comprising polyethylene and an outer layer comprising polyethylene.

In the second set of embodiments, the second layer is positioned between the first layer and the outer layer, the first layer is positioned between the second layer and the third layer, and the third layer is positioned between the first layer and the sealant layer.

In some embodiments of the second set of embodiments, the packaging film is free of polyamide.

In some embodiments of the second set of embodiments, the packaging film has a puncture resistance in accordance with ASTM F1306 of greater than about 15 Newtons and a tear resistance in accordance with ASTM D1922 in each of the machine direction and transverse direction of greater than about 160 gram-force.

In a third set of embodiments, this packaging film comprises a first layer comprising thermoplastic polyether polyurethane elastomer. The thermoplastic polyether polyurethane elastomer has a shore A hardness in accordance with DIN ISO 7619-1 (3s) of equal to or greater than about 70. In some embodiments, the thermoplastic polyether polyurethane elastomer has a shore A hardness in accordance with DIN ISO 7619-1 (3s) of equal to or greater than about 83. In some embodiments, the thermoplastic polyether polyurethane elastomer has a shore A hardness in accordance with DIN ISO 7619-1 (3s) of from about 83 to about 98.

In the third set of embodiments, the packaging film also comprises a second layer comprising a first tie material. In some embodiments, the first tie material contributes a bonding force of less than about 275.6 gram-force/centimeter (700 gram-force/inch). In some embodiments, the first tie material contributes a bonding force of from about 39.4 gram-force/centimeter (100 gram-force/inch) to about 118.1 gram-force/centimeter (300 gram-force/inch), In some of these embodiments, the packaging film has a tear resistance in accordance with ASTM D1922 in the machine direction of greater than about 900 gram-force and in the transverse direction of greater than about 1300 gram-force. The second layer is directly adjacent the first layer.

In the third set of embodiments, the packaging film also comprises a third layer comprising ethylene vinyl alcohol copolymer, a fourth layer comprising polyamide, a fifth layer comprising polyamide, and a sealant layer comprising polyethylene.

In the third set of embodiments, the second layer is positioned between the first layer and the fourth layer, the fourth layer is positioned between the second layer and the third layer, the third layer is positioned between the fourth layer and the fifth layer, and the fifth layer is positioned between the third layer and the sealant layer.

In the third set of embodiments, the packaging film is flattened upon itself at the first layer and thermally laminated to itself at the first layer. The packaging film is palindromic in structure, and the first layer is a core layer of the packaging film.

In some embodiments of the third set of embodiments, the packaging film has a puncture resistance in accordance with ASTM F1306 of greater than about 30 Newtons.

In some embodiments of the third set of embodiments, the packaging film is used as a liner for a bulk container and a fitment is attached to the liner.

### BRIEF DESCRIPTION OF THE DRAWINGS

FIG. 1 is a schematic cross-sectional view of a first embodiment of a packaging film according to the present application.

FIG. 2 is a schematic cross-sectional view of a second embodiment of a packaging film according to the present application.

FIG. 3 is a schematic cross-sectional view of a third embodiment of a packaging film according to the present application.

FIG. 4 is a schematic cross-sectional view of a fourth embodiment of a packaging film according to the present application.

FIG. 5 is a schematic cross-sectional view of a fifth embodiment of a packaging film according to the present application.

FIG. 6 is a schematic cross-sectional view of a sixth embodiment of a packaging film according to the present application.

FIG. 7 is a schematic top view of a liner for a bulk container formed from an embodiment of the packaging film described in the present application

### DETAILED DESCRIPTION

Referring to the drawings, with some but not all embodiments depicted, with elements depicted as illustrative and not necessarily to scale, and with the same (or similar) reference numbers denoting the same (or similar) features throughout the drawings, FIG. 1 is a schematic cross-sectional view of a first embodiment of a packaging film according to the present application. As used throughout this application, the term “film” refers to a thermoplastic web of any thickness and is not limited to a thermoplastic web having a thickness of less than about 250 micron (10 mil). The term “sheet” refers to a thermoplastic web of any thickness and is not limited to a thermoplastic web having a thickness of greater than about 250 micron (10 mil). As used throughout this application, the term “thermoplastic” refers to a polymer or polymer mixture that softens after exposure to heat and then returns to its original condition when cooled to room temperature.

As used throughout this application, the term “packaging” refers to any article used to wholly or partially surround or contain an item. Packaging may take many, various forms. For example, the term “packaging” may include pouches that wholly surround or contain an item (or items) to be packaged. The term “packaging” may also include films, sheets, etc. that partially surround or contain an item (or items) to be packaged and, when used in conjunction with another film, sheet, etc. wholly surround or contain an item (or items). As non-limiting examples, the term “packaging” includes pouches, bags, trays, cups, lidding materials, plates, bulk container liners, or other items.

As depicted in FIG. 1, packaging film 10 comprises first layer 12. First layer 12 comprises thermoplastic polyurethane elastomer (TPU), As used throughout this application, the term “thermoplastic polyurethane elastomer” or “TPU” refers to an elastomer formed by the inter-reaction of polyols (long-chain diols), diisocyanates, and short-chain diols. The polyols and the short-chain diols react with the diisocyanates through polyaddition to form linear polyurethane. The reaction of the polyol with the diisocyanate produces flexible segments of the TPU. The combination of the diisocyanate with the short-chain diols produces rigid segments of the TPU. Non-limiting examples of polyols that may be used include polyether-based polyols, which produce a thermoplastic polyether polyurethane elastomer, and polyester-based polyols, which produce a thermoplastic polyester polyurethane elastomer. Each of the polyether-based polyols and the polyester-based polyols may be aliphatic or aromatic. In various embodiments of the present application, the TPU of first layer 12 comprises a thermoplastic polyether polyurethane elastomer or a thermoplastic polyester polyurethane elastomer. Non-limiting examples of thermoplastic polyether polyurethane elastomers include those in the Elastollan® 11 Series (such as various grades of 1170 A. 1175 A, 1180 A, 1185 A. 1190 A, 1195 A. 1198 A, 1154 D, 1160 D, 1164 D, or 1174 D), the Elastollan® 12 Series (such as various grades of 1285 A, 1290 A, 1295 A, 1298 A. 1254 D, 1260 D, 1264 D, 1278 D, 1283 D), the Elastollan® A Series (such as various grades of A 1182 A. A 1185 A, or A 1154 D), the Elastollan® L Series (such as various grades of L 1185 A, L 1160 D, or L 1275 A), or Elastollan® Soft Products (such as various grades of SP 1145 A, SP 1150 A, SP 1155 A, or 1160 A). Non-limiting examples of thermoplastic polyester polyurethane elastorners include those in the Elastollan® C Series (such as various grades of C 78 A, C 80 A, C 85 A, C 88 A, C 90 A, C 95 A, C 98 A, C 59 D, C 60 D, C 64 D, or C 74 D), the Elastollan® B Series (such as various grades of B 80 A, B 85 A, B 90 A, B 95 A, B 98 A, B 60 D, or B 64 D), the Elastollan® A Series (such as various grades of A C 88 A), the Elastollan® L Series (such as various grades of L 785 A, L 765 D, or L 780 D), or the Elastollan® Soft Products (such as various grades of Soft 35 A, Soft 45 A, 565 A, 560 A, 565 A, or B 60 A). Each of the Elastollan® TPU's described above is commercially available from BASF Corporation (Florham Park, N.J.).

The TPU of first layer 12 has a shore A hardness of equal to or greater than about 35. The TPU of first layer 12 may also have a shore D hardness of equal to or less than about 85. As used throughout this application, each of the terms “shore A hardness” and “shore D hardness” refers to a material's resistance to indentation. The shore A scale is generally used for “softer” rubbers while the shore D scale is generally used for “harder” ones. However, one material may have each of a shore A hardness and a shore D hardness. As used throughout this application, each of shore A hardness and shore D hardness is measured in accordance with DIN ISO 7619-1 (“Rubber, Vulcanized or Thermoplastic—Determination of Indentation Hardness—Part 1: Durometer Method (Shore Hardness)”) at a test time of 3 seconds (i.e., “DIN ISO 7619-1 (3s)”). In other various embodiments of the present application, the TPU of first layer 12 may have a shore A hardness of equal to or greater than about 70; a shore A hardness of equal to or greater than about 83; a shore A hardness of from about 83 to about 98; a shore A hardness of from about 85 to about 98; or a shore A hardness of 85, 86, 87, 88, 89, 90, 91, 92, 93, 94, 95, 96, 97, or 98; a shore D hardness of equal to or less than about 75; a shore D hardness of equal to or less than about 52; a shore D hardness of from about 36 to about 52; a shore D hardness of 36, 37, 38, 39, 40, 41, 42, 43, 44, 45, 46, 47, 48, 49, 50, 51, or 52; or various combinations of the above. As non-limiting examples, the TPU may have a shore A hardness of equal to or greater than about 83 and a shore D hardness of equal to or less than 85; the TPU may have a shore A hardness of equal to or greater than about 70 and a shore D hardness of equal to or less than about 75; the TPU may have a shore A hardness of equal to or greater than about 83 and a shore D hardness of equal to or less than about 52; the TPU may have a shore A hardness of from about 83 to about 98 and a shore D hardness of from about 36 to about 52; the TPU may have a shore A hardness of 85 and a shore D hardness of 36; or the TPU may have a shore A hardness of 98 and a shore D hardness of 52.

As depicted in FIG. 1, first layer 12 is an inner layer of packaging film 10. As used throughout this application, the term “inner layer” refers to a layer that is positioned between two other layers. In other words, an inner layer comprises an inner surface on each surface. The term “inner surface” refers to a surface touching another layer, while the term “outer surface” refers to a surface not touching another layer. First layer 12 comprises first inner surface 12a and second inner surface 12b. While not depicted in FIG. 1, packaging film 10 comprises an additional layer or additional layers positioned exterior to first layer 12. As used throughout this application, the term “exterior” refers to a relative position closer to the outermost surface of a film, sheet, web, package, or other article. The term “interior” refers to a relative position closer to the innermost surface of a film, sheet, web, package, or other article. The phrase “positioned exterior” may be contrasted with the term “exterior layer.” The term “exterior layer” refers to a layer comprising the outermost surface of a film, sheet, web, package, or other article, e.g., the layer to be most distant from package contents. Similarly, the phrase “positioned interior” may be contrasted with the term “interior layer.” The term “interior layer” refers to a layer comprising the innermost surface of a film, sheet, web, package, or other article, e.g., the layer to be most adjacent to package contents. The exterior layer and the interior layer each have an inner surface and an outer surface. As described above, the term “inner layer” refers to a layer having an inner surface on each surface and is distinct from an interior layer.

Packaging film 10 also comprises second layer 14. Second layer 14 is directly adjacent first layer 12, As used throughout this application, the term “directly adjacent” refers to touching, having a common boundary, or having direct contact. In the embodiment depicted in FIG. 1, second layer 14 is positioned interior to first layer 12.

Second layer 14 comprises a first tie material. As used throughout this application, the term “tie material” or “tie” refers to a polymeric material serving a primary purpose or function of adhering two surfaces to one another, such as the planar surfaces of two sheet or film layers. For example, a tie material adheres one sheet layer surface to another sheet layer surface or one area of a sheet layer surface to another area of a sheet layer surface. Tie material may comprise any polymer, homopolymer, copolymer, or blend of polymers having a polar group or any other polymer, homopolymer, copolymer, or blend of polymers, including modified and unmodified polymers (such as grafted copolymers) which provide sufficient interlayer adhesion to directly adjacent layers comprising otherwise non-adhering polymers. Specific non-limiting examples of tie materials are DuPont™ Bynel® 21E533, DuPont™ Bynel® 41E710, and DuPont™ Bynel® 41E687 (each available from E.I. du Pont de Nemours and Company, Inc. (Wilmington, Del.)); Plexar® PX3747 and Plexar® PX3227 (each available from LyondellBasell Industries (Houston, Tex.)); Tymax™ GT4157, Tymax™ GT4524, and Tymax™ GT4300 (each available from Westlake Chemical Corporation (Houston, Tex.)); and ADMER@ SF755A (available from Mitsui Chemicals America, Inc. (Rye Brook, N.Y.)).

In various embodiments of the present application, depending on the desired bonding force between directly adjacent layers, tie material may include a single tie material, blends of tie materials, or a blend of tie material with polyethylene, including but not limited to linear low density polyethylene (LLDPE), such as Dowlex® 2045G and Dowlex® 2654G (each available from The Dow Chemical Company (Midland, Mich.)). As non-limiting examples, tie material may comprise solely DuPont™ Bynel® 21E533 or may comprise a blend of DuPont™ Bynel® 21E533, DuPont™ Bynel® 41E710, and Dowlex® 20450 or may comprise a blend of DuPont™ Bynel®41E710 and Dowlex® 2045G. In various embodiments of the present application, as non-limiting examples, the first tie material may contribute a bonding force between directly adjacent layers of equal to or greater than about 275.6 gram-force/centimeter (700 gram-force/inch) or may contribute a bonding force between adjacent layer of less than about 275.6 gram-force/centimeter (700 gram-force/inch) or may contribute a bonding force of from about 39.4 gram-force/centimeter (100 gram-force/inch) to about 118.1 gram-force/centimeter (300 gram-force/inch) or otherwise. In the various embodiments, the first tie material contributes sufficient bonding force to prevent complete delamination of the first layer from other layers in the packaging film.

As used throughout this application, the term “polyethylene” or “PE” refers (unless indicated otherwise) to ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. PE includes, for example, medium density polyethylene, high density polyethylene, low density polyethylene, ethylene alpha-olefin copolymers, ethylene vinyl acetate copolymers, ethylene acid copolymers, ethylene acrylate copolymers, cyclic olefin copolymers, or blends of such materials, Various PE's may be recycled as reclaimed PE.

As used throughout this application, the term “high density polyethylene” or “HDPE” refers to both (a) homopolymers of ethylene which have densities from 0.960 g/cm to 0,970 g/cm³ and (b) copolymers of ethylene and an alpha-olefin (usually 1-butene or 1-hexene) which have densities from 0.940 g/cm³ to 0.958 g/cm³. HDPE includes polymers made with Ziegler or Phillips type catalysts and polymers made with single-site metallocene catalysts. HDPE also includes high molecular weight “polyethylenes.”

As used throughout this application, the term “low density polyethylene” or “LDPE” refers to branched homopolymers having densities from 0.915 g/cm³ to 0.930 g/cm³, as well as copolymers containing polar groups resulting from copolymerization (such as with vinyl acetate or ethyl acrylate). LDPE may contain long branches off the main chain (often termed “backbone”) with alkyl substituents of two to eight carbon atoms.

As used throughout this application, the terms “copolymer of ethylene and at least one alpha-olefin” or “ethylene alpha-olefin copolymer” refer to a modified or unmodified copolymer produced by the co-polymerization of ethylene and any one or more alpha-olefins. Suitable alpha-olefins include, for example, C₃ to C₂₀alpha-olefins such as 1-propene, 1-butene, 1-pentene, 1-hexene, 1-octene, 1-decene, or blends of such materials. The co-polymerization of ethylene and an alpha-olefin may be produced by heterogeneous catalysis, such as co-polymerization reactions with Ziegler-Natta catalysis systems, including, for example, metal halides activated by an organometallic catalyst (e.g., titanium chloride) and optionally containing magnesium chloride complexed to trialkyl aluminum. Alternatively, the co-polymerization of ethylene and an alpha-olefin may be produced by homogeneous catalysis, such as co-polymerization reactions with metallocene catalysis systems which include constrained geometry catalysts, (e.g., monocyclopentadienyl transition-metal complexes). Homogeneous catalyzed copolymers of ethylene and alpha-olefin may include modified or unmodified ethylene alpha-olefin copolymers having a long-chain branched (i.e., 8-20 pendant carbons atoms) alpha-olefin co-monomer (commercially available as, for example, Affinity™ from The Dow Chemical Company (Midland, Mich.)), linear copolymers (commercially available as, for example, Tafmer™ from the Mitsui Petrochemical Corporation (Tokyo, Japan)), or modified or unmodified ethylene alpha-olefin copolymers having a short-chain branched (i.e., 3-6 pendant carbons atoms) alpha-olefin co-monomer (commercially available as, for example, Exact™ from ExxonMobil Chemical Company (Houston, Tex.)). Ethylene alpha-olefin copolymers may include, for example, linear low density polyethylene (LLDPE), metallocene-catalyzed LLDPE (mLLDPE), very low density polyethylene (VLDPE), metallocene-catalyzed VLDPE (mVLDPE), and ultra low density polyethylene (ULDPE). In some embodiments, linear low density polyethylene (including LLDPE and mLLDPE) may have a density of from 0,910 g/cm³ to 0.945 g/cm³. In some embodiments, very low density and ultra low density polyethylene (including VLDPE, mVLDPE, and ULDPE) may have a density of from 0.87 g/cm³ to 0.92 g/cm.

As used throughout this application, the term “ethylene vinyl acetate” or “EVA” refers to copolymers comprised of repeating units of ethylene and vinyl acetate. Ethylene vinyl acetate copolymers may be represented by the general formula: [(CH₂—CH₂)ₙ—(CH₂—CH(COO)(CH₃)]ₙ. The vinyl acetate content may vary from less than 10% to greater than 95% by weight (of total EVA composition). The vinyl acetate content of EVA for packaging applications may vary from 5% to 40% by weight.

As used throughout this application, the term “ethylene acid copolymers” refers to copolymers comprised of repeating units of ethylene and acid groups. The acid group content may vary from 2% to 25% by weight. Non-limiting examples of ethylene acid copolymers include ethylene methacrylic acid (EMAA) and ethylene acrylic acid (EAA).

As used throughout this application, the term “ethylene acrylate copolymers” refers to copolymers comprised of repeating units of ethylene and acrylate groups. The acrylate group may be butyl-, ethyl-, methyl-, or otherwise. Non-limiting examples of ethylene acrylate copolymers include ethylene methyl acrylate (EMA) and ethylene methyl methacrylate (EMMA).

As used throughout this application the term “cyclic olefin copolymer” or ‘COC” refers to a class of polymeric materials based on cyclic olefin monomers and ethane, with one or more different cyclic olefin units randomly or alternately attached to an ethylene polymer backbone, Ethylene/norbornene copolymers are a non-limiting example of cyclic olefin copolymers.

Returning to FIG. 1, packaging film 10 also comprises third layer 16. Third layer 16 is positioned interior to each of first layer 12 and second layer 14. In various embodiments, such as that depicted in FIG. 1, third layer 16 may be directly adjacent second layer 14. In other embodiments, the third layer may not be directly adjacent the second layer, and other layers may be positioned between the third layer and the second layer. Third layer 16 comprises first surface 16a, which is an inner surface, and second surface 16b, which may be an inner surface (if packaging film 10 comprises an additional layer or additional layers positioned interior to third layer 16) or an outer surface (if third layer 16 is the interior layer of packaging film 10, i.e., if packaging film 10 does not comprise an additional layer positioned interior to third layer 16).

Third layer 16 comprises ethylene vinyl alcohol copolymer. As used throughout this application, the term “ethylene vinyl alcohol copolymer” or “EVOH” refers to copolymers comprised of repeating units of ethylene and vinyl alcohol, Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol, Ethylene vinyl alcohol copolymers may comprise from 28 mole percent (or less) to 48 mole percent (or greater) ethylene.

EVOH also includes but is not limited to retortable-grade EVOH. As used throughout this application, the term “retortable-grade EVOH” refers to an EVOH that can be formed into a packaging film and a package, filled with an oxygen sensitive product, sealed, and heated to, for example, a temperature of from 104° C. to 149° C. (220° F. to 300° F.) for an extended period of time, for example, from 10 to 60 minutes, under high pressure (such as in the presence of water, steam, or pressurized steam) as known by a person of ordinary skill in the shelf-stable packaging arts, without delamination of the EVOH layer from the adjacent layers of the film, without the voiding of the EVOH and subsequent oxygen barrier loss, and without any other compromise of the EVOH during the retort process.

In some embodiments, the third layer may further comprise a polyester elastomer, as described in, for example, U.S. Pat. No. 9,701,445 (Witthuhn, et al.). A non-limiting example of a polyester elastomer is Hytrel® 4053FG NC010, which is commercially available from E.I. du Pont de Nemours and Company, Inc. (Wilmington, Del.).

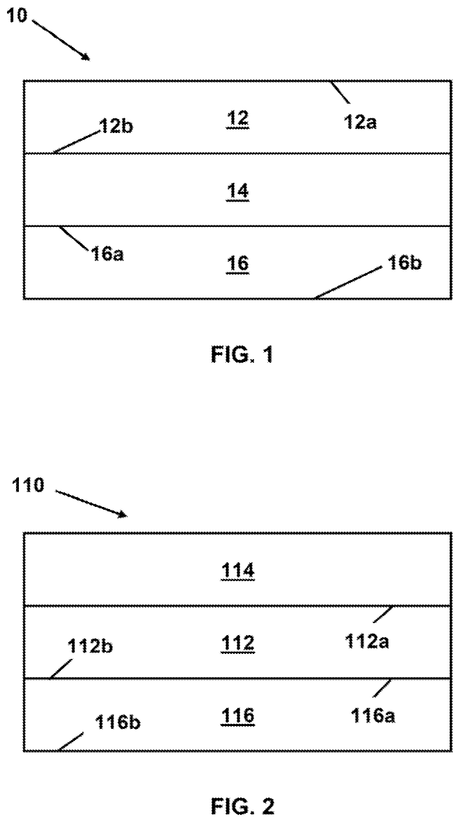

FIG. 2 is a schematic cross-sectional view of a second embodiment of a packaging film according to the present application. Packaging film 110 comprises first layer 112. First layer 112 comprises TPU, as described above, First layer 112 is an inner layer of packaging film 110 and comprises first inner surface 112a and second inner surface 112b.

Packaging film 110 also comprises second layer 114. As in packaging film 10, second layer 114 of packaging film 110 is directly adjacent first layer 112. As contrasted to packaging film 10 as depicted in FIG. 1 and as described above, in the embodiment depicted in FIG. 2, second layer 114 of packaging film 110 is positioned exterior to first layer 112. Second layer 114 comprises a first tie material, as described above.

Packaging film 110 also comprises third layer 116. Third layer 116 is positioned interior to each of first layer 112 and second layer 114. In various embodiments, such as that depicted in FIG. 2, third layer 116 may be directly adjacent first layer 112. In other embodiments, the third layer may not be directly adjacent the first layer, and other layers may be positioned between the third layer and the first layer. Third layer 116 comprises first surface 116a, which is an inner surface, and second surface 116b, which may be an inner surface (if packaging film 110 comprises an additional layer or additional layers positioned interior to third layer 116) or an outer surface (if third layer 116 is the interior layer of packaging film 110, i.e. if packaging film 110 does not comprise an additional layer positioned interior to third layer 116). Third layer 116 comprises ethylene vinyl alcohol copolymer, as described above.

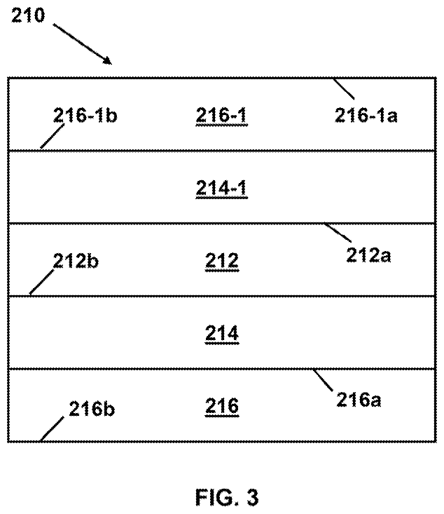

FIG. 3 is a schematic cross-sectional view of a third embodiment of a packaging film according to the present application. Packaging film 210 comprises first layer 212. First layer 212 comprises TPU, as described above. First layer 212 is an inner layer of packaging film 210 and comprises first inner surface 212a and second inner surface 212b. Additionally, first layer 212 is a core layer of packaging film 210. As used throughout this application, the term “core layer” refers to a layer positioned central or in the center of a packaging film, such that an equal number of layers are positioned exterior to and interior to the core layer.

Packaging film 210 also comprises second layer 214 and additional second layer 214-1. Each of second layer 214 and additional second layer 214-1 is directly adjacent first layer 212. Second layer 214 is positioned interior to first layer 212, and additional second layer 214-1 is positioned exterior to first layer 212. Each of second layer 214 and additional second layer 214-1 comprises a first tie material, as described above. Second layer 214 and additional second layer 214-1 may comprise the same or different first tie material.

Packaging film 210 also comprises third layer 216 and additional third layer 216-1. Each of third layer 216 and additional third layer 216-1 comprises ethylene vinyl alcohol copolymer, as described above. Third layer 216 and additional third layer 216-1 may comprise the same or different EVOH or may comprise a single EVOH or a blend of two or more EVOH. Third layer 216 is positioned interior to each of first layer 212 and second layer 214. In various embodiments, such as that depicted in FIG. 3, third layer 216 may be directly adjacent second layer 214. In other embodiments, the third layer may not be directly adjacent the second layer, and other layers may be positioned between the third layer and the second layer. Third layer 216 comprises first surface 216a, which is an inner surface, and second surface 216b, which may be an inner surface (if packaging film 210 comprises an additional layer or additional layers positioned interior to third layer 216) or an outer surface (if third layer 216 is the interior layer of packaging film 210, i.e., if packaging film 210 does not comprise an additional layer positioned interior to third layer 216). Additional third layer 216-1 is positioned exterior to each of first layer 212 and additional second layer 214-1. In various embodiments, such as that depicted in FIG. 3, additional third layer 216-1 may be directly adjacent additional second layer 214-1. As described above, in other embodiments, the additional third layer may not be directly adjacent the additional second layer, and other layers may be positioned between the additional third layer and the additional second layer. Additional third layer 216-1 comprises first surface 216-1a, which may be an inner surface (if packaging film 210 comprises an additional layer or additional layers positioned exterior to additional third layer 216-1) or an outer surface (if additional third layer 216-1 is the exterior layer of packaging film 210, i.e., if packaging film 210 does not comprise an additional layer positioned exterior to additional third layer 216-1), and second surface 216-1b, which is an inner surface.

The various packaging films described in this present application may be palindromic or non-palindromic in structure. As used throughout this application, the term “palindromic” refers to a structure having substantially symmetrical layers. Non-limiting examples of palindromic films are films having the layer configurations AB/A, A/B/B/A, A/B/C/B/A, A/B/C/D/E/D/C/F/C/D/E/D/C/B/A, etc. A non-limiting example of non-palindromic film is a film having the layer configuration NB/C/A. If second layer 214 and additional second layer 214-1 comprise the same first tie material and third layer 216 and additional third layer 216-1 comprise the same EVOH, packaging film 210 depicted in FIG. 3 and described above is palindromic in structure.

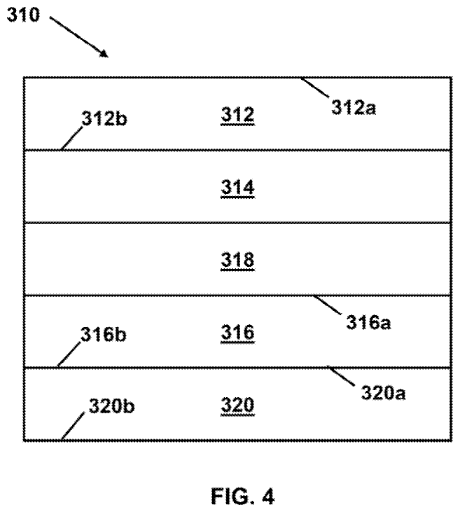

FIG. 4 is a schematic cross-sectional view of a fourth embodiment of a packaging film according to the present application. Packaging film 310 comprises first layer 312. First layer 312 comprises TPU, as described above. First layer 312 is an inner layer of packaging film and comprises first inner surface 312a and second inner surface 312b. While not depicted in FIG. 4, packaging film 310 comprises an additional layer or additional layers positioned exterior to first layer 312.

Packaging film 310 also comprises second layer 314. Second layer 314 is directly adjacent first layer 312. In the embodiment depicted in FIG. 4, second layer 314 is positioned interior to first layer 312. Second layer 314 comprises a first tie material, as described above.

Packaging film 310 also comprises third layer 316. Third layer comprises ethylene vinyl alcohol copolymer, as described above. Third layer 316 is positioned interior to each of first layer 312 and second layer 314. In the embodiment depicted in FIG. 4, third layer 316 is not directly adjacent second layer 314, as packaging film 310 also comprises fourth layer 318 positioned between second layer 314 and third layer 316. Packaging film 310 also further comprises fifth layer 320 positioned interior to third layer 316. As such third layer 316 comprises first inner surface 316a and second inner surface 316b. Fifth layer 320 comprises first surface 320a, which is an inner surface, and second surface 320b, which may be an inner surface (if packaging film 310 comprises an additional layer or additional layers positioned interior to fifth layer 320) or an outer surface (if fifth layer 320 is the interior layer of packaging film 310, i.e., if packaging film 310 does not comprise an additional layer positioned interior to fifth layer 320).

Each of fourth layer 318 and fifth layer 310 comprises polyamide. Fourth layer 318 and fifth layer 320 may comprise the same or different polyamide or may comprise a single polyamide or a blend of two or more polyamide. As used throughout this application, the term “polyamide” or “PA” or “nylon” refers to a homopolymer or copolymer having recurring amide linkages. The amide linkage may be represented by the general formula: [C(O)—R—C(O)—NH—R′—NH], where R and R′ are the same or different alkyl (or aryl) group. Polyamides may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine, and isophorone diamine. Non-limiting examples of suitable diacids include terephthalic acid, isophthalic acid, 2,5-furandicarboxylic acid, succinic acid, adipic acid, azelaic acid, capric acid, and lauric acid. Polyamides may also be formed by the ring-opening polymerization of suitable cyclic lactams like ε-caprolactam, ω-undecanolactam, and ω-dodecalactam. Polyamides may be high-temperature, low-temperature, or amorphous, as described in, for example, International Publication Number WO 2006/063283, Examples of polyamide polymers include but are not limited to nylon 6 (polycaprolactam), nylon 11 (polyundecanolactam), nylon 12 (polydodecalactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 6,6 (polyoctamethylene suberamide), nylon 9,9 (polynonamethylene azelamide), nylon 10,9 (polydecamethylene azelamide), and nylon 12,12 (polydodecamethylene dodecanediamide). Examples of polyamide copolymers include but are not limited to nylon 6,6/6 copolymer (polyhexamethylene adipamide/caprolactam copolymer), nylon 6,6/9 copolymer (polyhexamethylene adipamide/azelamide copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), and nylon 6,6/6,9/6 copolymer (polyhexamethylene adipamide/hexamethylene azelamide/caprolactam copolymer). Examples of aromatic polyamide polymers (also sometimes referred to as “amorphous polyamide” or “amorphous nylon”) include but are not limited to nylon 4,1, nylon 6,1, nylon 6,6/61 copolymer, nylon 6,6/6T copolymer, nylon MXD6 (poly-m-xylylene adipamide), poly-p-xylylene adipamide, nylon 6I/6T copolymer (polyhexamethylene terephthalamidelhexamethylene isophthalamide copolymer), nylon 6T/6I copolymer, nylon MXDI, nylon 6/MXDT/I copolymer, nylon 6T (polyhexamethylene terephthalamide), nylon 12T (polydodecamethylene terephthalamide), nylon 66T, and nylon 6-3-T (poly(trimethyl hexamethylene terephthalamide). In some embodiments, a polyamide layer or polyamide layers may further comprise a polyester elastomer, as described above.

In the embodiment depicted in FIG. 4, second layer 314 is positioned between first layer 312 and fourth layer 318, fourth layer 318 is positioned between second layer 314 and third layer 316, and third layer 316 is positioned between fourth layer 318 and fifth layer 320.

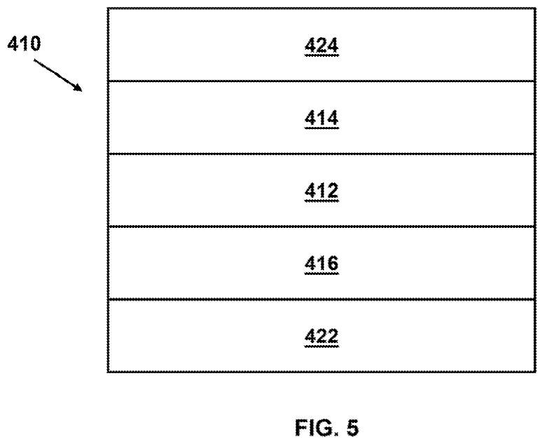

FIG. 5 is a schematic cross-sectional view of a fifth embodiment of a packaging film according to the present application, Packaging film 410 comprises first layer 412. First layer 412 comprises thermoplastic polyether polyurethane elastomer, as described above. This thermoplastic polyether polyurethane elastomer has a shore A hardness of equal to or greater than about 70. This thermoplastic polyether polyurethane elastomer may also have a shore D hardness of equal to or less than about 75. (As described above, as used throughout this application, each of shore A hardness and shore D hardness is measured in accordance with DIN ISO 7619-1 (“Rubber, Vulcanized or Thermoplastic—Determination of Indentation Hardness—Part 1: Durometer Method (Shore Hardness)”) at a test time of 3 seconds (i.e., “DIN ISO 7619-1 (3s)”).) In other embodiments of this fifth embodiment, the thermoplastic polyether polyurethane elastomer may have a shore A hardness of equal to or greater than about 83. The thermoplastic polyether polyurethane elastomer may also have a shore D hardness of equal to or less than about 52. And in still further embodiments of this fifth embodiment, the thermoplastic polyether polyurethane elastomer may have a shore A hardness of from about 83 to about 98. The thermoplastic polyether polyurethane elastomer may also have a shore D hardness of from about 36 to about 52. As depicted in FIG. 5, first layer 412 is an inner layer of packaging film 410.

Packaging film 410 also comprises second layer 414. Second layer 414 is directly adjacent first layer 414. Second layer 414 comprises a first tie material, as described above.

Packaging film 410 also comprises third layer 416, Third layer 416 comprises ethylene vinyl alcohol copolymer, as described above. As depicted in FIG. 5, third layer 416 is positioned interior to each of first layer 412 and second layer 414.

Packaging film 410 also comprises sealant layer 422. As used throughout this application, the term “sealant layer” refers to the specific layer of the film involved in the sealing of the film to itself or to another film or packaging component and is at least the interior layer of the packaging film. In some embodiments, the sealant layer may also be the exterior layer or other layers of the packaging film, in addition to the interior layer. Sealant layer 422 comprises polyethylene, as described above.

Packaging film 410 also comprises outer layer 424. Outer layer 424 is the exterior layer of packaging film 410. Outer layer 424 comprises polyethylene, as described above.

In the embodiment depicted in FIG. 5, second layer 414 is positioned between first layer 412 and outer layer 424, first layer 412 is positioned between second layer 414 and third layer 416, and third layer 516 is positioned between first layer 412 and sealant layer 422.

In some embodiments of this fifth embodiment, the packaging film may include no polyamide. In other words, the packaging film may be free of polyamide. In these embodiments, as exemplified and further described in the Examples below, the absence of polyamide has no negative effective on the mechanical toughness of the packaging film.

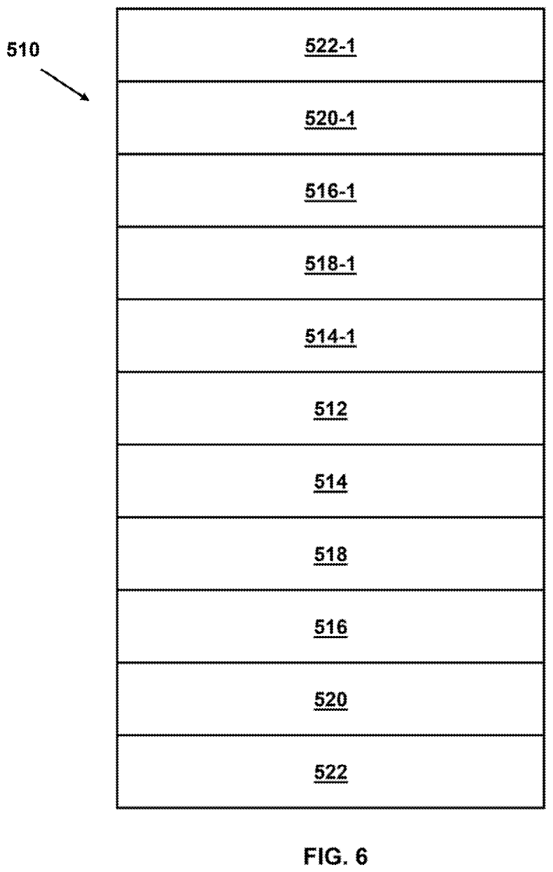

FIG. 6 is a schematic cross-sectional view of a sixth embodiment of a packaging film according to the present application. Packaging film 510 comprises first layer 512. First layer 512 comprises thermoplastic polyether polyurethane elastomer, as described above. This thermoplastic polyether polyurethane elastomer has a shore A hardness of equal to or greater than about 70. This thermoplastic polyether polyurethane elastomer may also have a shore D hardness of equal to or less than about 75. In other embodiments of this sixth embodiment, the thermoplastic polyether polyurethane elastomer may have a shore A hardness of equal to or greater than about 83. The thermoplastic polyether polyurethane elastomer may also have a shore D hardness of equal to or less than about 52. And in still further embodiments of this sixth embodiment, the thermoplastic polyether polyurethane elastomer may have a shore A hardness of from about 83 to about 98. The thermoplastic polyether polyurethane elastomer may also have a shore D hardness of from about 36 to about 52.

Packaging film 510 also comprises second layer 514. Second layer 514 is directly adjacent first layer 514. Second layer 514 comprises a first tie material, as described above. In various embodiments of this sixth embodiment, the first tie material may contribute a bonding force between directly adjacent layers of less than about 275.6 gram-force/centimeter (700 gram-force/inch) or may contribute a bonding force of from about 39.4 gram-force/centimeter (100 gram-force/inch) to about 118.1 gram-force/centimeter (300 gram-force/inch) or otherwise.

Packaging film 510 also comprises third layer 516. Third layer 516 comprises ethylene vinyl alcohol copolymer, as described above. As depicted in FIG. 6, third layer 516 is positioned interior to each of first layer 512 and second layer 514.

Packaging film 510 also comprises fourth layer 518 and fifth layer 520. Each of fourth layer 518 and fifth layer 520 comprises polyamide, as described above.

Packaging film 510 also comprises sealant layer 522, Sealant layer 522 comprises polyethylene, as described above.

In the embodiment depicted in FIG. 6, second layer 514 is positioned between first layer 512 and fourth layer 518, fourth layer 518 is positioned between second layer 514 and third layer 516, third layer 516 is positioned between fourth layer 518 and fifth layer 520, and fifth layer 520 is positioned between third layer 516 and sealant layer 522.

In various embodiments, such as when packaging film 510 is formed by the blown film coextrusion process (whereby various resins are heated and extruded through various dies to form a multilayer coextruded tubular extrudate (or “bubble” or “blown bubble”)), packaging film 510 may be formed as a result of a blown tubular extrudate being flattened upon itself at first layer 512 and thermally laminated to itself at first layer 512. This results in packaging film 510 being palindromic in structure, with first layer 512 as a core (or central) layer of packaging film 510 and with additional second layer 514-1, additional third layer 516-1, additional fourth layer 518-1, additional fifth layer 520-1, and additional sealant layer 522-1.

In addition to the blown film coextrusion process in which the blown tubular extrudate is flattened upon itself at first layer 512 and thermally laminated to itself at first layer 512, the packaging film described in the present application may be produced by various other methods.

For example, the blown film coextrusion process may be used where the tubular extrudate is collapsed and flattened upon itself without the tubular extrudate being thermally laminated to itself at the first layer. In such embodiments, the flattened tubular extrudate is slit to form two separate plies, with, for example, each separate ply on a separate packaging film roll or each separate ply double wound on a single packaging film roll. The packaging film described in the present application may also be produced by various other methods, including but not limited to cast extrusion or coextrusion, lamination, coating, etc.

As a further non-limiting example, in the lamination process, a first film (such as, a blown film, a cast film, or otherwise) and a second film (such as, a blown film, a cast film, or otherwise) are acquired or produced. In some embodiments, the first film may be adhesively laminated to the second film to produce a roll of packaging film. In other embodiments, the first film may be thermally laminated to the second film to product a roll of packaging film.

In some embodiments, the packaging film is non-oriented; in other words, no additional orientation is introduced other than that inherent in the production process, such as the typical blown film coextrusion process, cast extrusion process, lamination process, etc.

No matter the method of producing, the packaging film described in the present application may be used in any one of a variety of packaging configurations or forms (or packages) known to a person of ordinary skill in the packaging arts. Possible packaging configurations include but are not limited to horizontal-form-fill-seal package, vertical form-fill-seal package, lap-seal package, fin-seal package, quad-seal package, three-side-seal package, four-side-seal package, quad-pack, pouch, stand-up pouch, K-seal pouch, doyen-style pouch, side-gusset pouch, pillow pouch, stick pack, sachet, forming/non-forming package, thermoformed tray with lid, bulk container liners, or other packaging configurations known to a person of ordinary skill in the packaging arts.

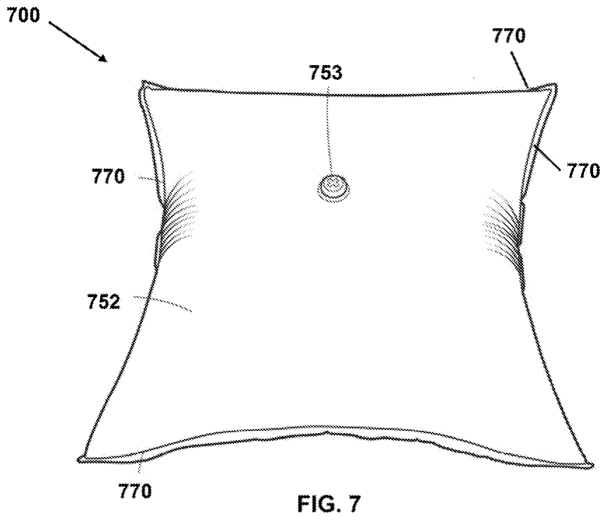

In one embodiment, the packaging film (such as, as a non-limiting example, packaging film 510 depicted in FIG. 6 and described above) may be used to form a liner for a bulk container such as a drum or an intermediate bulk container (IBC). FIG. 7 is a schematic top view of a liner for a bulk container formed from an embodiment of the packaging film described in the present application. Liner 700 comprises a first wall 752 comprising packaging film that is connected to a second wall (not shown) comprising packaging film at perimeter seal 770. In the embodiment of FIG. 7, fitment 753 is attached to first wall 752 of liner 700; however, in other embodiments, a fitment is optional and may or may not be included as part of the liner. In various embodiments, a bulk container liner comprising the packaging film described in the present application may be used without additional packaging materials. In other words, such liner may be used without any foam dunnage or may be used “dunnage-free.”

The various embodiments of the packaging film described in the present application may exhibit various properties, as exemplified and further described in the Examples below.

For example, a packaging film such as packaging film 410 in FIG. 5 as described above, when free of polyamide may have a puncture resistance of greater than about 15 Newtons and a tear resistance in each of the machine direction and transverse direction of greater than about 160 gram-force.

As a further example, a packaging film such as packaging film 510 in FIG. 6 as described above may have a puncture resistance of greater than about 30 Newtons. Packaging film 510 in FIG. 6 as described above when including a first tie material that contributes a bonding force of from about 39.4 gram-force/centimeter (100 gram-force/inch) to about 118.1 gram-force/centimeter (300 gram-force/inch) may have a tear resistance in the machine direction of greater than about 900 gram-force and in the transverse direction of greater than about 1300 gram-force.

As used throughout this application, the term “puncture resistance” refers to the slow rate penetration (e.g., one inch per minute) resistance of a material to a driven probe (e.g., a one-eighth-inch-diameter hemispherical probe) at room temperature. For the present application, puncture resistance was determined in accordance with ASTM F1306-90 (Reapproved 2008) (“Standard Test Method for Slow Rate Penetration Resistance of Flexible Barrier Films and Laminates”). ASTM F1306 provides methods for determining the force, energy, and elongation to perforation. For the present application, puncture is considered the force to perforation, i.e., the peak force to break. As such, puncture values are reported in Newtons.

As used throughout this application, the term “tear resistance” refers to the force to propagate tearing through a length of material after the tear has been initiated, using an Elmendorf-type (pendulum) tearing tester. For the present application, tear resistance was determined in accordance with ASTM D1922-09 (“Standard Test Method for Propagation Tear Resistance of Plastic Film and Thin Sheeting by Pendulum Method”). Tear resistance values are reported as tearing force, such as gram-force. A high tear resistance value generally reflects a material that is more difficult to tear. Tear resistance may be determined for each of the machine direction and the transverse direction of a packaging film. As used throughout this application, the term “machine direction” or “MD” refers to the direction of film transport during or after extrusion or film conversion. As used throughout this application, the term “transverse direction” or “TD” refers to the direction perpendicular to the machine direction.

Other various properties of the packaging film of the present application include its tensile strength, oxygen transmission rate, and flex-crack resistance.

As used throughout this application, the term “tensile strength” refers to the stress a material can withstand while being pulled or stretched without breaking. In other words, tensile strength is the capacity of a material to resist tensile loads without fracture. For the present application, tensile strength was determined in accordance with ASTM D882-12 (“Standard Test Method for Tensile Properties of Thin Plastic Sheeting”), using a 50-millimeter (2-inch) initial grip separation and a 500 mm/min (20 inch/min) rate of grip separation. Tensile strength values are reported as the force per unit area, such as in MPa or psi. Tensile strength may be determined for each of the machine direction and transverse direction of a packaging film.

As used throughout this application, the term “oxygen transmission rate” or “OTR” refers to the rate of the transmission of oxygen gas through a material. For the present application, OTR was determined in accordance with ASTM D3985 (“Standard Test Method for Oxygen Gas Transmission Rate Through Plastic Film and Sheeting Using a Coulometric Sensor”). Oxygen transmission rate values are reported as cc/m²/day.

As used throughout this application, the term “flex-crack resistance (Gelbo)” refers to a material's resistance against repetitive strain. It is also referred to as flex durability. For the present application, flex-crack resistance (Gelbo) was determined by attaching a sample of packaging film to Gelbo flex-tester mandrels and subjecting the sample to a twisting motion combined with a horizontal motion (compression), thus repeatedly twisting and crushing the sample. For the present application, each sample was of similar size and was subjected to 45 cycles per minute for one hour (for a total of 2700 cycles) at various temperatures (such as 23° C. and 3° C.). The sample material was then examined for pinholes, A blue dye solution (Toluidine Blue) was used and allowed to stain through the pinholes onto an absorbent white backing to facilitate detection and counting of pinholes. Flex crack resistance (Gelbo) values are reported as the number of pinholes in the sample.

### EXAMPLES

To further exemplify the various embodiments of the present application, several example and comparative example packaging films were produced and evaluated for various properties.

TABLE 1 provides information regarding the composition of various blown films. In producing the blown films, various materials were added to the extruders of a blown film line. In addition to the materials listed in TABLE 1, various layers included various processing aids known to a person of ordinary skill in the packaging arts.

Each of Examples 1-5 and Comparative Examples 1-2 were formed by collapsing the tubular extrudate and flattening it upon itself (at layer 7) such that the two inner tubular extrudate layers thermally laminated to themselves to form one core layer at layer 7. Each of Examples 1-5 and Comparative Examples 1-2 had a thickness of about 114 micron (4.5 mil), Each of Examples 6-7 and Comparative Examples 3-4 were formed such that the tubular extrudate was collapsed and flattened upon itself but not thermally laminated to itself; the flattened tubular extrude was slit to form two separate plies. Each of Examples 3-4 and Comparative Example 3-4 had a thickness of about 57 micron (2.25 mil).

TABLE 1

| | Layer | | | | | | | | | | | | |
|---|---|---|---|---|---|---|---|---|---|---|---|---|---|
| | 1 | | | | | | | | | | | | |
| | (interior | Layer | Layer | Layer | Layer | Layer | Layer | Layer | Layer | Layer | Layer | Layer | Layer |
| | layer) | 2 | 3 | 4 | 5 | 6 | 7 | 8 | 9 | 10 | 11 | 12 | 13 |
| Example 1 | LLDPE | Tie | nylon | EVOH + | nylon | Tie 1 | TPU 1 | Tie 1 | nylon | EVOH + | nylon | Tie | LLDPE |
| | | | 6/6,6 + | polyester | 6/6,6 + | | | | 6/6,6 + | polyester | 6/6,6 + | | |
| | | | polyester | elastomer | polyester | | | | polyester | elastomer | polyester | | |
| | | | elastomer | | elastomer | | | | elastomer | | elastomer | | |
| Example 2 | LLDPE | Tie | nylon | EVOH + | nylon | Tie 2 | TPU 1 | Tie 2 | nylon | EVOH + | nylon | Tie | LLDPE |
| | | | 6/6,6 + | polyester | 6/6,6 + | | | | 6/6,6 + | polyester | 6/6,6 + | | |
| | | | polyester | elastomer | polyester | | | | polyester | elastomer | polyester | | |
| | | | elastomer | | elastomer | | | | elastomer | | elastomer | | |
| Example 3 | LLDPE | Tie | nylon | EVOH + | nylon | Tie 3 | TPU 1 | Tie 3 | nylon | EVOH + | nylon | Tie | LLDPE |
| | | | 6/6,6 + | polyester | 6/6,6 + | | | | 6/6,6 + | polyester | 6/6,6 + | | |
| | | | polyester | elastomer | polyester | | | | polyester | elastomer | polyester | | |
| | | | elastomer | | elastomer | | | | elastomer | | elastomer | | |
| Example 4 | LLDPE | Tie | nylon | EVOH + | nylon | Tie 1 | TPU 2 | Tie 1 | nylon | EVOH + | nylon | Tie | LLDPE |
| | | | 6/6,6 + | polyester | 6/6,6 + | | | | 6/6,6 + | polyester | 6/6,6 + | | |
| | | | polyester | elastomer | polyester | | | | polyester | elastomer | polyester | | |
| | | | elastomer | | elastomer | | | | elastomer | | elastomer | | |
| Example 5 | LLDPE | Tie | nylon | EVOH + | nylon | Tie 2 | TPU 2 | Tie 2 | nylon | EVOH + | nylon | Tie | LLDPE |
| | | | 6/6,6 + | polyester | 6/6,6 + | | | | 6/6,6 + | polyester | 6/6,6 + | | |
| | | | polyester | elastomer | polyester | | | | polyester | elastomer | polyester | | |
| | | | elastomer | | elastomer | | | | elastomer | | elastomer | | |
| Compar- | LLDPE | Tie | nylon | EVOH + | nylon | Tie 3 | LLDPE | Tie 3 | nylon | EVOH + | nylon | Tie | LLDPE |
| ative | | | 6/6,6 + | polyester | 6/6,6 + | | | | 6/6,6 + | polyester | 6/6,6 + | | |
| Example 1 | | | polyester | elastomer | polyester | | | | polyester | elastomer | polyester | | |
| | | | elastomer | | elastomer | | | | elastomer | | elastomer | | |
| Compar- | ULDPE | Tie | nylon | EVOH + | nylon | Tie 3 | ULDPE | Tie 3 | nylon | EVOH + | nylon | Tie | ULDPE |
| ative | | | 6/6,6 + | polyester | 6/6,6 + | | | | 6/6,6 + | polyester | 6/6,6 + | | |
| Example 2 | | | polyester | elastomer | polyester | | | | polyester | elastomer | polyester | | |
| | | | elastomer + | | elastomer + | | | | elastomer + | | elastomer + | | |
| | | | nylon 6 | | nylon 6 | | | | nylon 6 | | nylon 6 | | |
| Example 6 | LLDPE | Tie | EVOH + | Tie | TPU 2 | Tie 1 | LDPE | | | | | | |
| | | | polyester | | | | | | | | | | |
| | | | elastomer | | | | | | | | | | |
| Example 7 | LLDPE | Tie | EVOH + | Tie | TPU 2 | Tie 2 | LDPE | | | | | | |
| | | | polyester | | | | | | | | | | |
| | | | elastomer | | | | | | | | | | |
| Compar- | LLDPE | Tie | EVOH + | Tie | LDPE | Tie 3 | LDPE | | | | | | |
| ative | | | polyester | | | | | | | | | | |
| Example 3 | | | elastomer | | | | | | | | | | |
| Compar- | ULDPE | Tie | nylon | EVOH + | nylon | Tie 3 | ULDPE | | | | | | |
| ative | | | 6/6,6 + | polyester | 6/6,6 + | | | | | | | | |
| Example 4 | | | polyester | elastomer | polyester | | | | | | | | |
| | | | elastomer + | | elastomer + | | | | | | | | |
| | | | nylon 6 | | nylon 6 | | | | | | | | |

TPU 1 is a thermoplastic polyether polyurethane elastomer having a shore A hardness of 85 and a shore D hardness of 36. TPU 2 is a thermoplastic polyether polyurethane elastomer having a shore A hardness of 98 and a shore D hardness of 52. Tie 1 is a first tie material contributing a bonding force equal to or greater than about 275.6 gf/cm (700 gf/inch). Tie 2 is a first tie material contributing a bonding force of about 118.1 gf/cm (300 gf/inch). Tie is a first tie material contributing a bonding force of about 39.4 gf/cm (100 gf/inch). Tie is a tie material contributing a non-specified bonding force.

Examples 1-5 and Comparative Examples 1-2 were evaluated for puncture resistance, tear resistance, tensile strength, OTR, and flex-crack resistance (Gelbo), TABLE 2 reports the results,

TABLE 2

| | | | | | | | Flex-crack | Flex-crack |
|---|---|---|---|---|---|---|---|---|
| | | | | Tensile | | | resistance | resistance |
| | | | | strength | | | (Gelbo) | (Gelbo) |
| | Puncture | Tear | | (MPa) | | | at 23° C. | at 3° C. |
| | resistance | resistance | | ((psi)) | | OTR | (number of | (number of |
| | (newtons) | MD | TD | MD | TD | (cc/m2/day) | pinholes) | pinholes) |
| Example 1 | 35.97 | 804 | 1288 | 36.98 | 36.44 | 0.75 | 12 | 24 |
| | | | | (5364) | (5285) | | | |
| Example 2 | 34.61 | 1069 | 1600 | 39.25 | 37.89 | 0.75 | 10 | 17 |
| | | | | (5693) | (5496) | | | |
| Example 3 | 39.53 | 1284 | 1600 | 42.13 | 41.31 | 0.75 | 6 | 10 |
| | | | | (6110) | (5992) | | | |
| Example 4 | 38.02 | 880 | 1434 | 43.00 | 39.31 | 0.75 | 11 | |
| | | | | (6237) | (5702) | | | |
| Example 5 | 40.37 | 1025 | 1600 | 45.85 | 42.25 | 0.75 | 12 | |
| | | | | (6650) | (6128) | | | |
| Comparative | 29.39 | 472 | 1310 | 40.87 | 33.32 | 0.8 | 19 | 20 |
| Example 1 | | | | (5928) | (4833) | | | |
| Comparative | 22.97 | 590 | 1082 | 31.97 | 31.07 | 1.3 | 11 | 18 |
| Example 2 | | | | (4637) | (4506) | | | |

Note:
(A tear resistance value of 1600 gf was the upper limit of the Elmendorf-type (pendulum) tearing tester for the TABLE 2 data set.)

As reported in TABLE 2, Examples 1-5 (in other words, various embodiments of the packaging film of the present application) demonstrated a significant improvement in mechanical toughness as compared to other packaging films, without any negative effect on oxygen barrier properties. Examples 1-5 also demonstrated a significant improvement in flex-crack resistance as compared to other packaging films. From qualitative, visual observation, Examples 1-5 also had no significant decrease in optical clarity as compared to other packaging films.

Examples 6-7 and Comparative Examples 3-4 were evaluated for puncture resistance, tear resistance, tensile strength, and flex-crack resistance (Gelbo). TABLE 3 reports the results.

TABLE 3

| | | | | | | Flex-crack |
|---|---|---|---|---|---|---|
| | | | | Tensile | | resistance |
| | | Tear | | strength | | (Gelbo) |
| | Puncture | resistance | | (MPa) | | at 23° C. |
| | resistance | (gf) | | ((psi)) | | (number of |
| | (newtons) | MD | TD | MD | TD | pinholes) |
| Example 6 | 21.51 | 266 | 400 | 34.52 | 32.18 | 3 |
| | | | | (5007) | (4667) | |
| Example 7 | 21.29 | 400 | 400 | 32.62 | 29.65 | 2 |
| | | | | (4731) | (4301) | |
| Comparative | 14.67 | 38 | 93 | 15.61 | 25.93 | 50+ |
| Example 3 | | | | (2264) | (3761) | |
| Comparative | 12.92 | 79 | 155 | 32.29 | 30.50 | |
| Example 4 | | | | (4683) | (4424) | |

Note:
(A tear resistance value of 400 gf was the upper limit of the Elmendorf-type (pendulum) tearing tester for the TABLE 3 data set.)

As reported in TABLE 3, Examples 6-7 (in other words, various embodiments of the packaging film of the present application) again demonstrated a significant improvement in mechanical toughness as compared to other packaging films. Examples 6-7 also demonstrated a significant improvement in flex-crack resistance as compared to other packaging films. And, as with Examples 1-5, from qualitative, visual observation, Examples 6-7 also had no significant decrease in optical clarity as compared to other packaging films.

Each and every document cited in this present application, including any cross-referenced or related patent or application, is incorporated in this present application in its entirety by this reference, unless expressly excluded or otherwise limited. The citation of any document is not an admission that it is prior art with respect to any embodiment disclosed or claimed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application (including the appended claims) governs.

Unless otherwise indicated, all numbers expressing sizes, amounts, ranges, limits, and physical and other properties used in the present application (including the appended claims) are to be understood as being preceded in all instances by the term “about.” Accordingly, unless expressly indicated to the contrary, the numerical parameters set forth in the present application (including the appended claims) are approximations that can vary depending on the desired properties sought to be obtained by a person of ordinary skill in the packaging arts without undue experimentation using the teachings disclosed in the present application.

As used in the present application (including the appended claims), the singular forms “a” “an,” and “the” encompass embodiments having plural referents, unless the context clearly dictates otherwise. As used in the present application (including the appended claims), the term “or” is generally employed in its sense including “and/or,” unless the context clearly dictates otherwise.

Spatially related terms, including but not limited to, “lower,” “upper,” “beneath,” “below,” “above,” “bottom,” and “top,” if used in the present application (including the appending claims), are used for ease of description to describe spatial relationships of element(s) to another. Such spatially related terms encompass different orientations of the package in use or operation, in addition to the particular orientations depicted in the drawings and described in the present application (including the appended claims). For example, if an object depicted in the drawings is turned over or flipped over or inverted, elements previously described as below or beneath other elements would then be above those other elements.

The description, examples, embodiments, and drawings disclosed are illustrative only and should not be interpreted as limiting. The present invention includes the description, examples, embodiments, and drawings disclosed; but it is not limited to such description, examples, embodiments, or drawings. The reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention as described in the claims.

What is claimed is as follows:

1. A packaging film comprising:
a first layer comprising a thermoplastic polyurethane elastomer, wherein the thermoplastic polyurethane elastomer comprises a thermoplastic polyether polyurethane elastomer or a thermoplastic polyester polyurethane elastomer and the thermoplastic polyurethane elastomer has a shore A hardness in accordance with DIN ISO 7619-1 (3s) equal to or greater than 35, and wherein the first layer is an inner layer of the packaging film;
a second layer comprising a first tie material, wherein the second layer is directly adjacent the first layer; and
a third layer comprising ethylene vinyl alcohol copolymer, wherein the third layer is positioned interior to each of the first layer and the second layer.

2. The packaging film of claim 1, wherein the thermoplastic polyurethane elastomer has a shore A hardness in accordance with DIN ISO 7619-1 (3s) equal to or greater than 83.

3. The packaging film of claim 1, wherein the thermoplastic polyurethane elastomer has a shore A hardness in accordance with DIN ISO 7619-1 (3s) from 83 to 98.

4. The packaging film of claim 1, wherein the first tie material contributes a bonding force less than 275.6 gram-force/centimeter (700 gram-force/inch).

5. The packaging film of claim 1, wherein the first tie material contributes a bonding force from 39.4 gram-force/centimeter (100 gram-force/inch) to 118.1 gram-force/centimeter (300 gram-force/inch).

6. The packaging film of claim 1, wherein the first layer is a core layer of the packaging film and the packaging film is palindromic in structure.

7. The packaging film of claim 1, further comprising a fourth layer comprising polyamide and a fifth layer comprising polyamide, wherein the second layer is positioned between the first layer and the fourth layer, the fourth layer is positioned between the second layer and the third layer, and the third layer is positioned between the fourth layer and the fifth layer.

8. A packaging film comprising:
a first layer comprising a thermoplastic polyether polyurethane elastomer, wherein the thermoplastic polyether polyurethane elastomer has a shore A hardness in accordance with DIN ISO 7619-1 (3s) equal to or greater than 70;
a second layer comprising a first tie material;
a third layer comprising ethylene vinyl alcohol copolymer,
a sealant layer comprising polyethylene, and
an outer layer comprising polyethylene,
wherein the second layer is directly adjacent the first layer and positioned between the first layer and the outer layer, wherein the first layer is positioned between the second layer and the third layer whereby the first layer is an inner layer of the packaging film, and wherein the third layer is positioned between the first layer and the sealant layer whereby the third layer is positioned interior to each of the first layer and the second layer.

9. The packaging film of claim 8, wherein the thermoplastic polyether polyurethane elastomer has a shore A hardness in accordance with DIN ISO 7619-1 (3s) equal to or greater than 83.

10. The packaging film of claim 8, wherein the thermoplastic polyether polyurethane elastomer has a shore A hardness in accordance with DIN ISO 7619-1 (3s) from 83 to 98.

11. The packaging film of claim 8, wherein the packaging film is free of polyamide.

12. The packaging film of claim 11, wherein the packaging film has a puncture resistance in accordance with ASTM F1306 greater than 15 Newtons and a tear resistance in accordance with ASTM D1922 in each of the machine direction and transverse direction greater than 160 gram-force.

13. A packaging film comprising:
a first layer comprising a thermoplastic polyether polyurethane elastomer, wherein the thermoplastic polyether polyurethane elastomer has a shore A hardness in accordance with DIN ISO 7619-1 (3s) equal to or greater than 70;
a second layer comprising a first tie material;
a third layer comprising ethylene vinyl alcohol copolymer,
a fourth layer comprising polyamide,
a fifth layer comprising polyamide, and
a sealant layer comprising polyethylene,
wherein the second layer is directly adjacent the first layer and positioned between the first layer and the fourth layer, wherein the fourth layer is positioned between the second layer and the third layer, wherein the third layer is positioned between the fourth layer and the fifth layer, wherein the fifth layer is positioned between the third layer and the sealant layer, and
wherein the packaging film is flattened upon itself at the first layer and thermally laminated to itself at the first layer, whereby the packaging film is palindromic in structure and the first layer is a core layer of the packaging film.

14. The packaging film of claim 13, wherein the thermoplastic polyether polyurethane elastomer has a shore A hardness in accordance with DIN ISO 7619-1 (3s) equal to or greater than 83.

15. The packaging film of claim 13, wherein the thermoplastic polyether polyurethane elastomer has a shore A hardness in accordance with DIN ISO 7619-1 (3s) from 83 to 98.

16. The packaging film of claim 13, wherein the first tie material contributes a bonding force less than 275.6 gram-force/centimeter (700 gram-force/inch).

17. The packaging film of claim 13, wherein the packaging film has a puncture resistance in accordance with ASTM F1306 greater than 30 Newtons.

18. The packaging film of claim 13, wherein the first tie material contributes a bonding force from 39.4 gram-force/centimeter (100 gram-force/inch) to 118.1 gram-force/centimeter (300 gram-force/inch).

19. The packaging film of claim 18, wherein the packaging film has a tear resistance in accordance with ASTM D1922 in the machine direction greater than 900 gram-force and in the transverse direction greater than 1300 gram-force.

20. The packaging film of claim 13, wherein the packaging film is used as a liner for a bulk container and a fitment is attached to the liner.
